(19) United States
(12) Patent Application Publication
(10) Pub. No.: US 2014/0234503 A1
(43) Pub. Date: Aug. 21, 2014

(54) Method and Composition

(71) Applicant: Natural Biotechnology SPRL, Courcelles (BE)

(72) Inventor: Jeffrey Ian Dodd, Lancashire (GB)

(21) Appl. No.: 14/348,848

(22) PCT Filed: Sep. 28, 2012
(86) PCT No.: PCT/GB2012/000749

§ 371 Date: Mar. 31, 2014

(30) Foreign Application Priority Data
Sep. 29, 2011 (GB) 1116817.6
Mar. 14, 2012 (GB) 1204512.6

(51) Int. Cl. A23B 7/10

(52) U.S. Cl. CPC A23B 7/105; A23V 2002/00
USPC 426/321; 426/654; 426/541

(57) ABSTRACT

There is described a method of preserving leafy vegetables which comprises treating the leafy vegetables with a processing aid composition, said processing aid composition comprising from about 0.01% w/w to 5% w/w salicylic acid; or a salt or ester thereof.

### FIELD OF THE INVENTION

The present invention relates to a novel composition and to novel methods related thereto.

More particularly, the invention relates a novel composition suitable for use in preventing the deterioration on storage of food crops, especially leafy vegetables, such as lettuce.

### BACKGROUND OF THE INVENTION

The Food and Agriculture Organisation of the United Nations reports that world production of lettuce and chicory for the calendar year 2007 was 23.55 million tons, primarily coming from China (51%), the USA (22%) and Spain (5%).

Top ten lettuce and chicory producers - 2007

| Country | Production (tonnes) |
|---|---|
| China | 12,000,000 |
| USA | 5,105,980 |
| Spain | 1,070,000 |
| South Africa | 875,000 |
| Italy | 850,078 |
| India | 790,000 |
| Japan | 560,000 |
| France | 471,000 |
| Turkey | 382,034 |
| Australia | 185,000 |
| Total | 23,550,943 |

There is an increasing consumer demand for fresh salads in the form of vegetable salads, e.g. green leaf salads. The salad must not only “keep” on storage, but also remain fresh for approximately seven days or more. Leafy salad vegetables have the inherent tendency to discolour and/or become sensorially unpalatable very quickly. This difficulty must also be overcome. The salads are of course to be ready-made, i.e. capable of being eaten with minimum preparation time required by the consumer. In the case of many green leafy vegetables, this means an increase in exposed surface area of more than one hundred-fold, which can create difficulties in respect of the produce staying fresh (in appearance, colour, taste, mechanical strength, etc.).

However, leafy vegetables, such as lettuce, are highly perishable, particularly of not refrigerated shortly after purchase.

Although packaged lettuce will often have a longer shelf life, usually due to modified atmosphere packaging, e.g. flushing out oxygen and carbon dioxide and infusing gasses such as nitrogen. However, once the pack is opened, the nitrogen escapes and the leaves are exposed to oxygen and carbon dioxide again. Alternatively, the shelf life of packaged lettuce may be extended by treating the lettuce with reagents, such as chlorine, etc.

The deterioration that occurs in leafy vegetables, such as lettuce, is twofold:

(i) browning caused by polyphenyloxidase enzymes; and
(ii) pinking, (pink rib) is the pink discoloration of the midrib caused by activity of the enzyme phenylalanine ammonia-lyase (PAL).

One of the most common postharvest browning disorders of whole head and cut iceberg lettuce tissue are russet spotting (RS), senescent browning (SB) and brown stain (BS) (Saltveit, 1997),

For browning to occur in lettuce PAL activity is required to form phenolics that are subsequently oxidized and polymerized. Altered phenolic metabolism is thought to be involved in lettuce tissue browning. The first committed step in the phenyl propanoid pathway is the conversion of the amino acid L-phenylalanine to trans-cinnamic acid by the enzyme phenyl alanine ammonia lyase.

Subsequent reactions produce several new compounds, among which 5-caffeoylquinic acid (chlorogenic acid), 3,5-dicaffeoylquinic acid, caffeoyl tartaric acid and dicaffeoyl tartaric acid have been associated with increased browning in lettuce (Toma's-Barbera'n et al, 1997a,b).

Browning of the uncut surfaces probably results from the stress of wounding during preparation that can induce PAL activity and compromise membrane integrity which disrupts cellular compartmentalization and allows poly-phenol oxidase to come into contact with the phenolics produced by PAL. In healthy cells, Poly-phenol oxidase is in the cytoplasm and the phenolic compounds are in the vacuole (Mayer, 1987). It has been shown that wounding can cause an increase in PAL activity up to 2.5 cm from the wound site in lettuce tissue (Ke and Saltveit, 1989a).

We have now surprisingly found that the use of very small amounts of salicylic acid can suitably preserve leafy vegetables, such as lettuce, etc.

Salicylic acid is found in most vegetables, fruits, and herbs; but it is found in abundance in the bark of willow trees, from where it was extracted for use in the early manufacture of aspirin (acetyl salicylic acid). Fruits, especially berries contain large amounts of salicylates. Therefore, salicylic acid is considered a safe alternative to existing preservatives, such as chlorine.

### SUMMARY OF THE INVENTION

According to a first aspect of the invention there is provided a method of preserving leafy vegetables which comprises treating the leafy vegetables with processing aid composition, said processing aid composition comprising from about 0.01% w/w to 5% w/w salicylic acid; or a salt or ester thereof.

The amount of salicylic acid; or a salt or ester thereof; present in the composition may vary depending upon, inter alia, the leafy vegetables being preserved. However, the amount of salicylic acid; or a salt or ester thereof, present in the composition may be preferably from about 0.02% w/w to about 0.9% w/w; preferably from about 0.03% w/w to about 0.8% w/w; preferably from about 0.04% w/w to about 0.7% w/w; preferably from about 0.05% w/w to about 0.6% w/w; preferably from about 0.06% w/w to about 0.5% w/w; preferably from about 0.07% w/w to about 0.4% w/w; preferably from about 0.08% w/w to about 0.3% w/w; preferably from about 0.09% w/w to about 0.2% w/w; most preferably about 0.1% w/w.

It is understood that leafy vegetables, especially salad leafy vegetables, such as, lettuce, have a matrix of calcium ions within their leaf structure. Therefore, in a preferred aspect of the invention the method of preserving leafy vegetables comprises treating the leafy vegetables with a processing aid composition, said processing aid composition comprising from about 0.01% w/w to 5% w/w salicylic acid; or a salt or ester thereof; and source of calcium ions, e.g. one or more calcium salts.

It will be understood by the person skilled in the art that any calcium salts conventionally known to be used as food processing aids may be used. Thus, the calcium ions may be in the form of one or more of the group consisting of calcium chloride, e.g. calcium chloride dehydrate, calcium hydroxide, calcium carbonate, calcium phosphate, calcium erythorbate, calcium acetate, calcium gluconate, calcium glycerophosphate, calcium lactate, calcium ascorbate, calcium salicylate and mixtures thereof. However, a preferred source of calcium ions is calcium salicylate.

According to this aspect of the invention the leafy vegetables may be treated with the calcium ions separately, simultaneously or sequentially with the salicylic acid; or a salt or ester thereof. However, it is preferred that the leafy vegetables are treated simultaneously with the calcium ions and the salicylic acid; or a salt or ester thereof, e.g. in the form of a composition comprising salicylic acid; or a salt or ester thereof; as hereinbefore described and calcium ions, for example, in the form of a calcium salt, such as calcium chloride. Calcium salicylate is particularly advantageous in that, inter alia, it provides the desirable calcium ions, without creating a source of chlorine, such as hypochlorite. Furthermore, it is postulated that the presence of calcium salicylate delays the onset of “pink rib”.

Therefore, the invention provides a method as hereinbefore described wherein the composition comprising from about 0.01% w/w to 5% w/w salicylic acid; or a salt or ester thereof; and source of calcium ions.

The amount of calcium salt present in the method of the invention may vary depending upon, inter alia, the leafy vegetables being preserved, the nature of the calcium salt, etc. However, the amount of calcium salt present in the method or composition may be preferably from about 65% w/w to about 95% w/w; preferably from about 68% w/w to about 92% w/w; preferably from about 70% w/w to about 90% w/w; preferably from about 73% w/w to about 87% w/w; preferably from about 75% w/w to about 85% w/w; preferably from about 78% w/w to about 82% w/w; preferably from about 79% w/w to about 81% w/w; most preferably about 80% w/w.

A composition, suitable for preventing enzymatic degeneration, e.g. browning or “pink rib” in leaf vegetable, comprising salicylic acid, or a salt or ester thereof, and a calcium salt is novel per se. Therefore, according to a further aspect of the invention there is provided a composition, suitable for preventing enzymatic degeneration, e.g. browning or “pink rib” in leaf vegetable, comprising salicylic acid; or a salt or ester thereof; and a calcium salt.

The amount of salicylic acid, or a salt or ester thereof, and the amount and/or nature of the calcium salt in the composition according to this aspect of the invention may be as hereinbefore described according to the method of the invention.

The method or composition of the invention may also include one or more antioxidants. Thus, for example, the antioxidant may comprise one or more of ascorbic acid and erythorbic acid, or a salt thereof

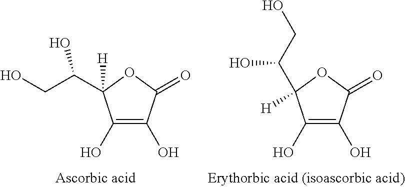 [SMILES: O=C1O[C@H]([C@@H](O)CO)C(O)=C1O ; O=C1O[C@H]([C@H](O)CO)C(O)=C1O]

However, a preferred antioxidant is ascorbic acid.

When an antioxidant, such as, ascorbic acid and erythorbic acid, or a salt thereof, is present in the method or composition of the invention, the amount may vary depending upon, inter alia, the leafy vegetables being preserved, the nature of the antioxidant, etc. However, the amount of antioxidant present in the method or composition may be preferably from about 5% w/w to about 25% w/w; preferably from about 8% w/w to about 22% w/w; preferably from about 10% w/w to about 20% w/w; preferably from about 12% w/w to about 18% w/w; preferably from about 13% w/w to about 17% w/w; preferably from about 14% w/w to about 16% w/w; most preferably about 15% w/w.

The method or composition of the invention may also include one or more acidulants. The acidulant may act to reduce the pH of the environment. Such one or more acidulants are desirably organic acids, such as, those selected from the group consisting of acetic acid, citric acid, fumaric acid, lactic acid, malic acid, phosphoric acid and tartaric acid; and mixtures thereof. A preferred acidulant is citric acid.

When an acidulant, such as, citric acid, is present in the method or composition of the invention, the amount may vary depending upon, inter alia, the leafy vegetables being preserved, the nature of the acidulant, etc. However, the amount of acidulant present in the method or composition may be preferably from about 1% w/w to about 10% w/w; preferably from about 2% w/w to about 8% w/w; preferably from about 3% w/w to about 7% w/w; preferably from about 4% w/w to about 6% w/w; preferably from about 4.5% w/w to about 5.5% w/w; preferably from about 4.8% w/w to about 5% w/w; most preferably about 4.9% w/w.

The invention further provides a method of preserving leafy vegetables which comprises treating the leafy vegetables with a processing aid composition, said processing aid composition comprising salicylic acid; or a salt or ester thereof; a calcium salt, an antioxidant and an acidulant.

In the method according to this aspect of the invention the composition comprises:

from about 0.01% w/w to 5% w/w salicylic acid, or a salt or ester thereof;
from about 65% w/w to about 95% (w/w) of a calcium salt,
from about 5% w/w to about 25% of an antioxidant and
from about 2% w/w to about 8% (w/v); of an acidulant;
not exceeding 100% w/w.

Preferably, in the method according to this aspect of the invention the composition comprises:

about 0.1% w/w salicylic acid, or a salt or ester thereof;
about 80% w/w of a calcium salt;
about 15% w/w of an antioxidant; and
about 4.9% w/w of an acidulant.

More preferably, in the method according to this aspect of the invention the composition comprises:

about 0.1% w/w salicylic acid, or a salt or ester thereof;
about 80% w/w of calcium chloride;
about 15% w/w of ascorbic acid, or a salt thereof,
about 4.9% w/w of citric acid.

Therefore, according to a yet further aspect of the invention there is provided a composition, suitable for preventing enzymatic degeneration, e.g. browning or “pink rib” in leaf vegetable, said composition comprising salicylic acid; or a salt or ester thereof; a calcium salt, an antioxidant and an acidulant.

More specifically, the composition according to this aspect of the invention comprises:

from about 0.01% w/w to 5% w/w salicylic acid, or a salt or ester thereof;
from about 65% w/w to about 95% w/w of a calcium salt,
from about 5% w/w to about 25% of an antioxidant and
from about 2% w/w to about 8% w/w; of an acidulant;
not exceeding 100% w/w.

Preferably the composition according to this aspect of the invention comprises:

about 0.1% w/w salicylic acid, or a salt or ester thereof;
about 80% w/w of a calcium salt;
about 15% w/w of an antioxidant; and
about 4.9% w/w of an acidulant.

More preferably, the composition according to this aspect of the invention comprises:

about 0.1% w/w salicylic acid, or a salt or ester thereof;
about 80% w/w of calcium chloride;
about 15% w/w of ascorbic acid, or a salt thereof, about 4.9% w/w of citric acid.

The composition of the invention is usually applied as a solution, e.g. an aqueous solution. The concentration may vary, but may be, for example, the working/dipping concentration is from about 0.1% w/v to about 15% w/v (e.g. about 1 gm/litre to 150 gm/litre), preferably from about 0.2% w/v to about 10% w/v from about 0.3% w/v to about 8% w/v from about 0.5% w/v to about 5% w/v, preferably from about 1% w/v to about 3% w/v.

According to a further aspect of the invention there is provided a processing aid composition for leafy salads, said processing aid composition comprising an anti-browning/anti-pinking effective amount of one or more of:

sorbic acid, or a salt thereof;
citric acid, or a salt thereof;
erythorbic acid, or a salt thereof;
ascorbic acid, or a salt thereof;
a calcium salt;
and optionally one or more of sucrose, tannic acid, salicylic acid and sodium hydrogen sulphate.

The calcium salt may be, for example, calcium chloride.

The invention further provides a method for protecting leafy salads, eg sliced/cut leafy salads, said method comprising washing said leafy salads in a processing aid effective amount of a processing aid composition comprising one or more of:

sorbic acid, or a salt thereof,
citric acid, or a salt thereof;
erythorbic acid, or a salt thereof;
ascorbic acid, or a salt thereof;
a calcium salt;
and optionally one or more of sucrose, tannic acid, salicylic acid and sodium hydrogen sulphate.

The invention further provides a leafy salad, eg sliced/cut leafy salad, comprising a processing aid effective amount of a processing aid composition one or more of:

sorbic acid, or a salt thereof;
citric acid, or a salt thereof;
erythorbic acid, or a salt thereof;
ascorbic acid, or a salt thereof;
a calcium salt;
and optionally one or more of sucrose, tannic acid, salicylic acid and sodium hydrogen sulphate.

The term “processing aid” shall include, for example, an agent that has antimicrobial properties and/or anti-browning properties and/or anti-pinking properties.

In a preferred aspect of the invention there is provided a processing aid composition for leafy salads, eg sliced/cut leafy salads, as herein before described, said processing aid composition comprising a processing aid effective amount of:

about 0.5 to 1.5% w/w of sorbic acid, or a salt thereof;
about 10 to 20% w/w of citric acid, or a salt thereof;
about 3 to 9% w/w of erythorbic acid, or a salt thereof;
about 33 to 53% w/w of ascorbic acid, or a salt thereof;
about 3 to 9% w/w of a calcium salt; and
about 19 to 39% w/w of sucrose.

The processing aid composition according to this aspect of the invention may include from about 0.5% to about 3% w/w of sorbic acid, or a salt thereof.

The processing aid composition may include from about 1% to about 20% w/w of citric acid, or a salt thereof.

The processing aid composition may include from about 1% to about 10% w/w of erythorbic acid, or a salt thereof.

The processing aid composition may include from about 10% to about 40% w/w of ascorbic acid, or a salt thereof.

The processing aid composition may include from about 3% to about 10% w/w of a calcium salt.

The processing aid composition may include from about 0.5% to about 9% w/w of tannic acid, or a salt thereof.

The processing aid composition may include from about 19% to about 39% w/w of sucrose.

The processing aid composition may include from about 0.5% to about 15% w/w of sodium hydrogen sulphate, or other hydrogen sulphate salt forms thereof.

More preferably there is provided a processing aid composition for leafy salads, eg sliced/cut leafy salads, as herein before described, said processing aid composition comprising a processing aid effective amount of:

from about 38% to about 43% w/w of ascorbic acid, or a salt thereof;
about 6% w/w of a calcium salt; and
from about 3% to about 29% w/w of sucrose;
about 1% w/w of sorbic acid, or a salt thereof;
about 15% w/w of citric acid, or a salt thereof;
about 6% w/w of erythorbic acid, or a salt thereof;
about 6% w/w of tannic acid, or a salt thereof; and
about 10% w/w of sodium hydrogen sulphate or other hydrogen sulphate salt forms thereof.

The term leafy vegetables shall include, but shall not be limited to one or more of amaranth (Amaranthus cruentus), arugula (Eruca sativa), beet greens (Beta vulgaris), Bitterleaf (Vernonia calvoana), bok Choy (Brassica rapa), broccoli rabe (Brassica rapa), brussels sprout (Brassica oleracea), cabbage (Brassica oleracea Capitata group), catsear (Hypochaeris radicata), celery (Apium graveolens), celtuce (Lactuca sativa var. asparagina), ceylon spinach (Basella alba), chard (Beta vulgaris), chaya (Cnidoscolus aconitifolius), chickweed (Stellaria), chicory (Cichorium intybus), chinese cabbage (Brassica rapa Pekinensis and Chinensis groups), chinese Mallow (Malva verticillata), chrysanthemum leaves (Chrysanthemum coronarium), collard greens (Brassica oleracea), corn salad (Valerianella locusta), cress (Lepidium sativum), dandelion (Taraxacum officinale), endive (Cichorium endivia), epazote (Chenopodium ambrosioides), fat hen (Chenopodium album), fiddlehead (Pteridium aquilinum, Athyrium esculentum), fluted pumpkin (Telfairia occidentalis), garden rocket (Eruca sativa), golden samphire (Inula crithmoides), good king henry (Chenopodium bonus-henricus), greater plantain (Plantago major), kai-lan (Brassica rapa), kale (Brassica oleracea Acephala group), komatsuna (Brassica rapa), kuka (Adansonia spp.), lagos bologi (Talinum fruticosum), lamb's lettuce (Valerianella locusta), land cress (Barbarea verna), lettuce (Lactuca sativa), lizard's tail (Houttuynia cordata), melokhia (Corchorus olitorius, Corchorus capsularis), miner's Lettuce, mizuna greens (Brassica rapa), mustard (Sinapis alba), napa cabbage (Brassica rapa), New Zealand spinach (Tetragonia tetragonioides), orache (Atriplex hortensis), pak Choy (Brassica rapa), paracress (Acmella oleracea), pea sprouts/leaves (Pisum sativum), poke (Phytolacca americana), radicchio (Cichorium intybus), aamphire (Crithmum maritimum), sea beet (Beta vulgaris), sea kale (Crambe maritima), soko (Celosia argentea), sorrel (Rumex acetosa), spinach (Spinacia oleracea), summer purslane (Portulaca oleracea), Swiss chard (Beta vulgaris), tatsoi (Brassica rapa), turnip greens (Brassica rapa), watercress (Nasturtium officinale), water spinach (Ipomoea aquatica), winter purslane (Claytonia perfoliata) and yarrow (Achillea millefolium).

The method and composition of the invention is found to be especially suitable for use in the prevention or slowing of browning and pinking in salad leaves, for example, lettuce, such as, Batavia, COS and Romaine, Iceberg, Little gem lettuce, Lollo Rosso lettuce, oak Leaf lettuce, round lettuce; other salad leaves, such as, chard, endive, escarole, mizuna, radicchio, rocket, spinach, tatsoi and watercress.

Desirably, the method of the invention comprises the application of a composition as hereinbefore described to a leafy vegetable post-harvest.

It has also been found that the shelf-life of the leafy vegetable may be further prolonged by varying the method of harvesting or preparing for consumption post-harvest. Conventionally, salad crops, such as lettuce are harvested by cutting the leafy plant away from the tap root using a sharp implement, for example a stainless steel knife or blade. However, we have surprisingly found that the crop experiences less stress if the vegetable is sheared, for example torn by hand or cut using a relatively blunt instrument. Such a relatively blunt instrument may, for example, be a plastic instrument rather than a metal bladed instrument, e.g. a plastic knife/blade.

Therefore, according to a yet further aspect of the invention there is provided a method of preserving leafy vegetables which comprises the steps of

(i) shearing the leafy vegetables into desirably sized portions; and
(ii) treating the sheared leafy vegetables with a processing aid composition, as hereinbefore described, for example, a processing aid composition comprising from about 0.01% w/w to 5% w/w salicylic acid; or a salt or ester thereof.

The term “salts” shall include, for example, alkali metal salts, e.g. sodium, potassium, etc, and combinations thereof, or alkaline earth metal salts, such as calcium, etc. and combinations thereof. Thus, a preferred salt of sorbic acid is potassium sorbate and/or calcium sorbate.

The invention will now be described by way of example only and with reference to the accompanying figures, in which the figures pictorially represent an Iceberg lettuce dip trial in which Iceberg lettuce leaves and stalks were dipped in the composition of the invention (Example 1) and in which:

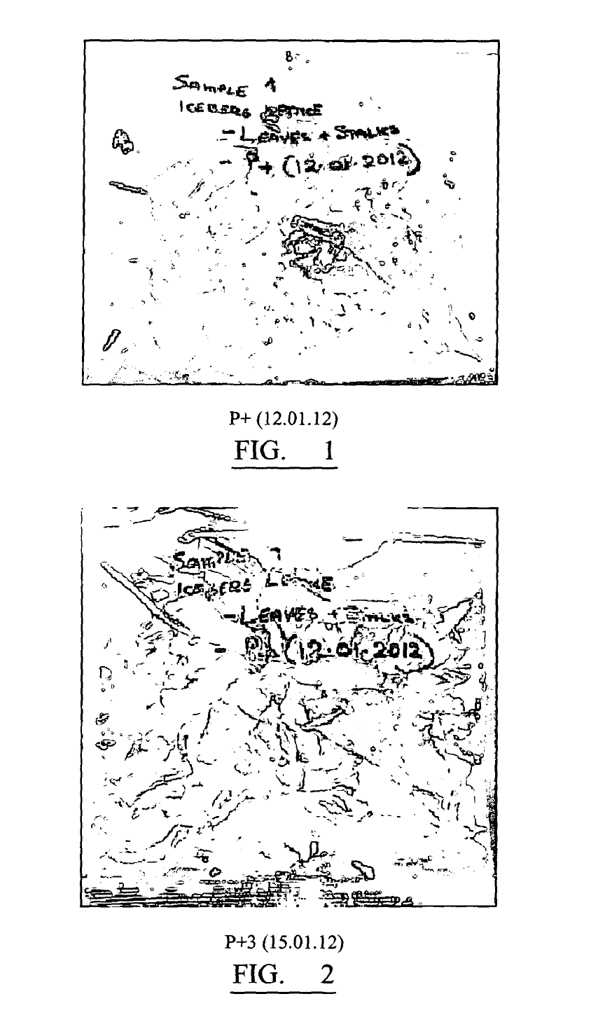

FIG. 1 illustrates the sample on day 1;

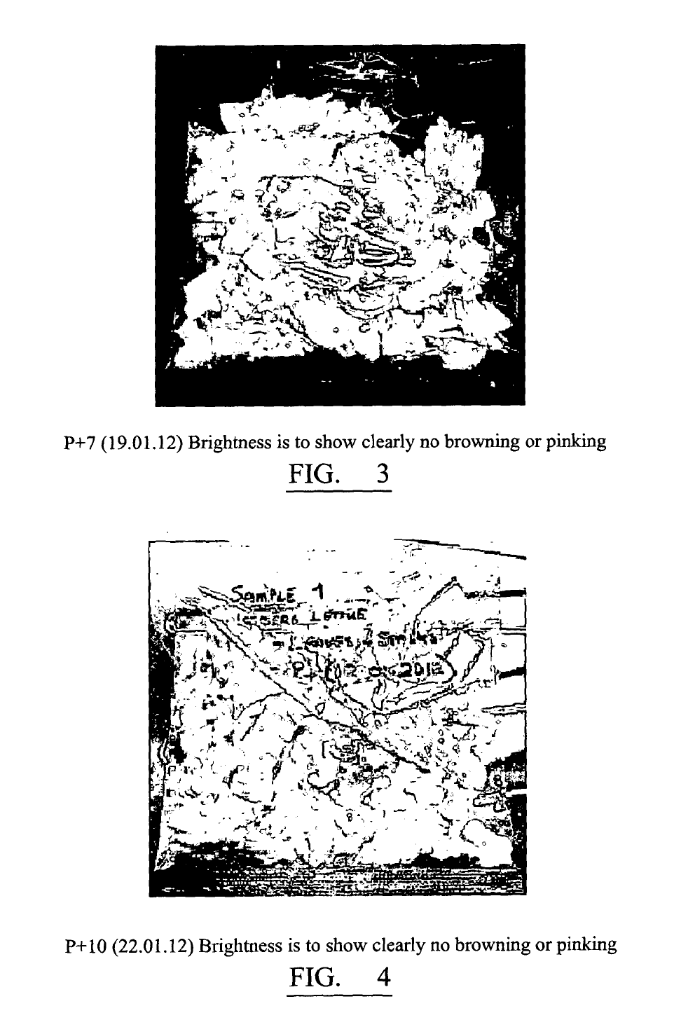

FIG. 2 illustrates the sample on day 3;

FIG. 3 illustrates the sample on day 7, the brightness is to show clearly no browning or pinking;

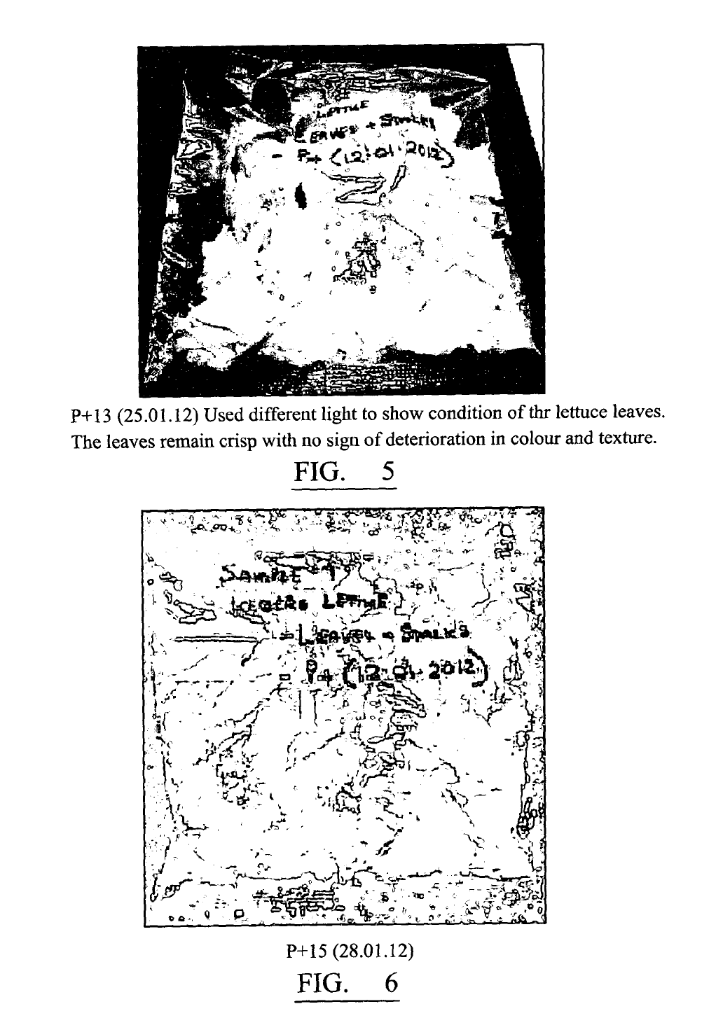

FIG. 4 illustrates the sample on day 10, the brightness is to show clearly no browning or pinking;

FIG. 5 illustrates the sample on day 13, different light was used to show condition of the lettuce leaves;

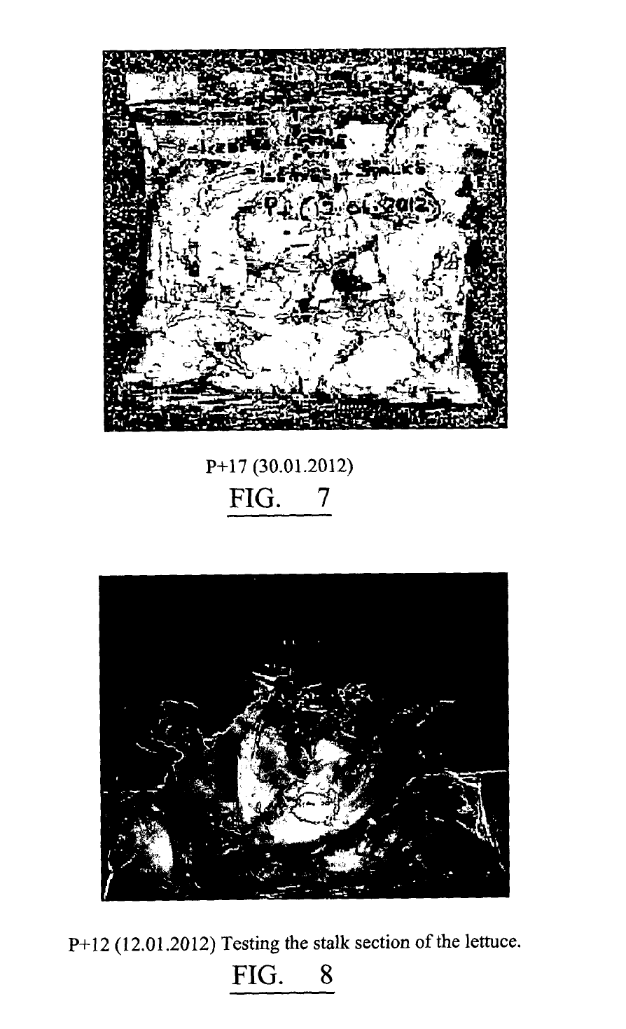

FIG. 6 illustrates the sample on day 15;

FIG. 7 illustrates the sample on day 17;

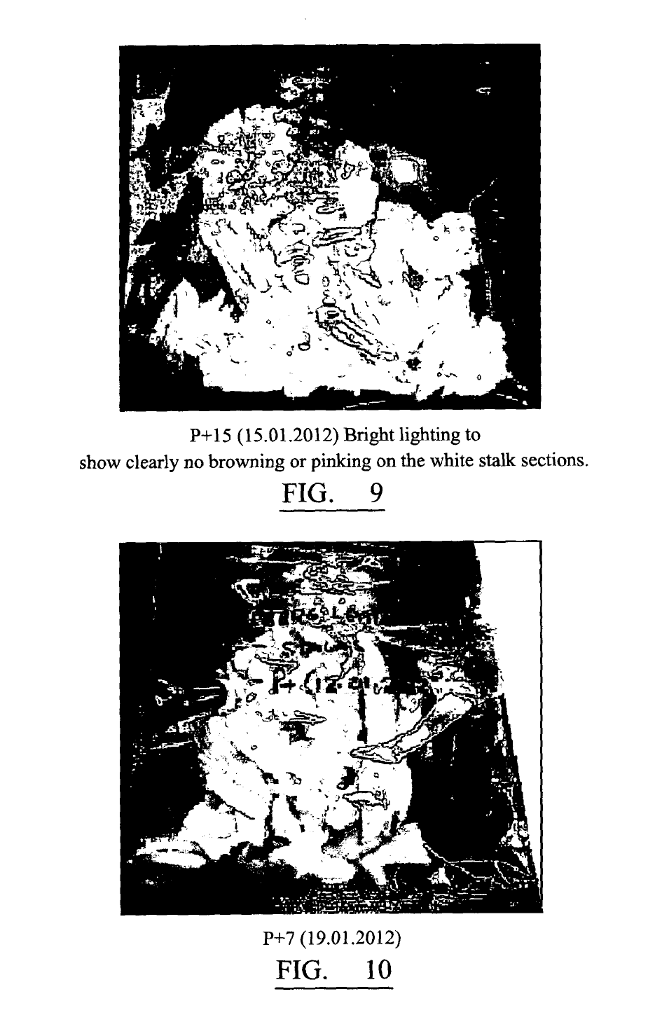

FIG. 8 illustrates a test of the stalk section of the lettuce the sample on day 1;

FIG. 9 illustrates a test of the stalk section of the lettuce the sample on day 3, bright lighting to show clearly no browning or pinking on the white stalk sections;

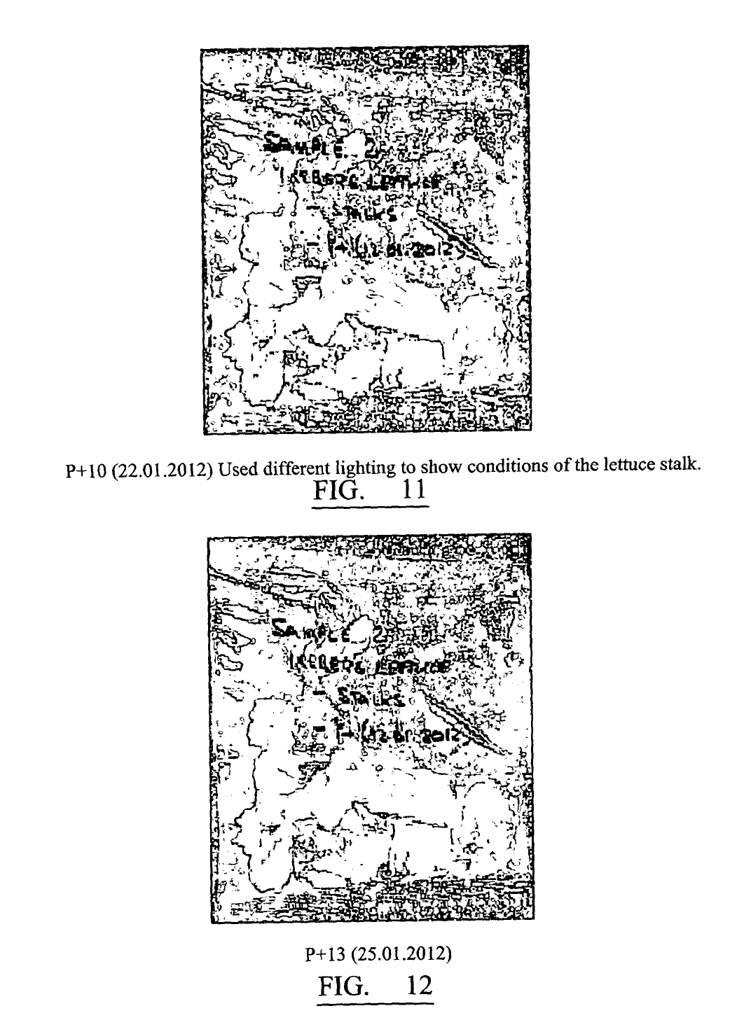

FIG. 10 illustrates a test of the stalk section of the lettuce the sample on day 7;

FIG. 11 illustrates a test of the stalk section of the lettuce the sample on day 10, different lighting used to show condition of the lettuce stalk;

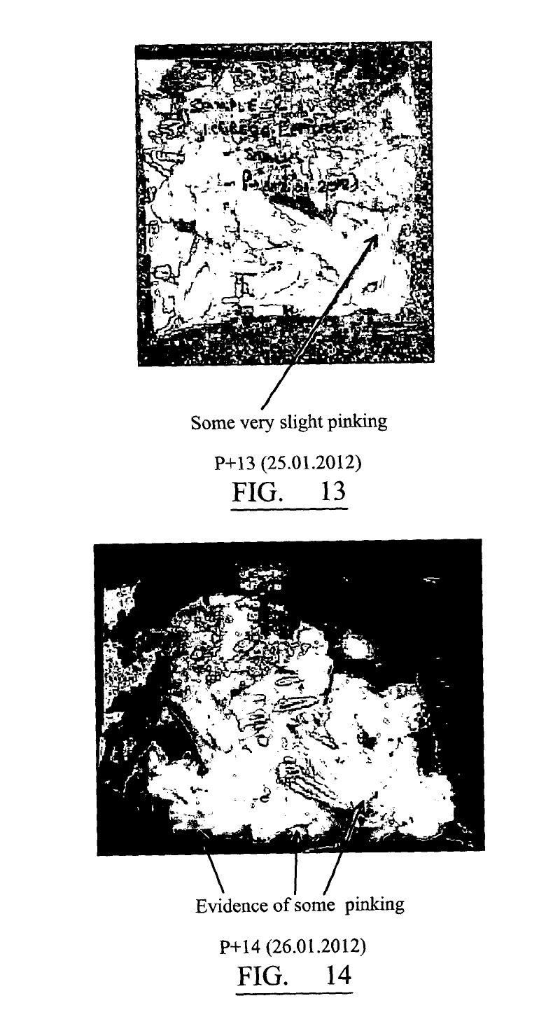

FIG. 12 illustrates a test of the stalk section of the lettuce the sample on day 13;

FIG. 13 illustrates a test of the stalk section of the lettuce the sample on day 13, with some slight pinking evident;

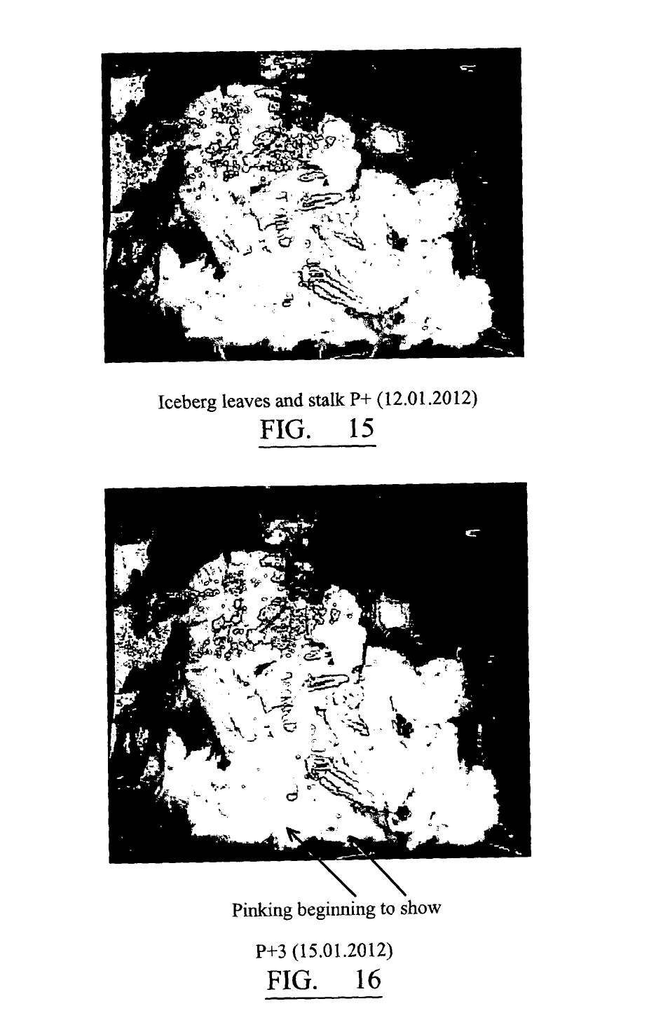

FIG. 14 illustrates a test of the stalk section of the lettuce the sample on day 14, with some slight pinking evident;

FIG. 15 illustrates a control sample of undipped Iceberg leaves & stalk on day 1;

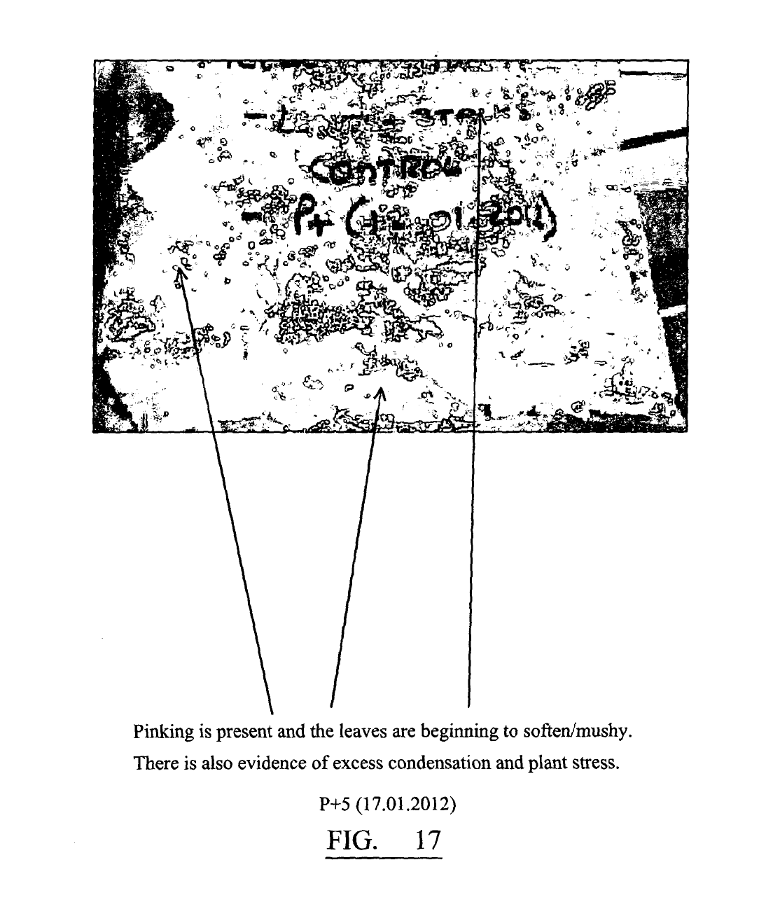

FIG. 16 illustrates a control sample of undipped Iceberg leaves & stalk on day 3, with pinking beginning to show; and

FIG. 17 illustrates a control sample of undipped Iceberg leaves & stalk on day 5, pinking is present and the leaves are beginning to soften.

### EXAMPLE 1

Objective:

1. To establish the number of day's shelf life which could can be achieved using the ABS 600 (composition of the invention) technology.
2. To establish the number of times a bag could opened before browning or pinking appeared on the lettuce.

Trial Data:

The formulation designated ABS 600 used is a blend of natural organic intermediates which are approved for use in food applications.

The ABS 600 concentration used is 2.5%.

The Dip Time was one (1) minute at 10° C.

Final Storage is at 4° C.-6° C. in a, heat sealed semi-permeable plastic bag.

Summary Procedure:

The Iceberg lettuce was purchased from the local market.

Preparation: (Trial was Started at 09:00 Hrs on the Dec. 12, 2012

1. The outer lettuce leaves were carefully detached from the lettuce head using a knife.
2. The tap stalk was then detached using a knife.
3. The lettuce was then halved each half then being halved again leaving four equal quarters.
4. The quarters were then sliced into equal width lengths and then separating the lettuce sections and placing these loose sections into a colander.

Dipping:

5. The lettuce sections were then removed from the colander and placed into the ABS 600 2% Solution for a dip time of one to five (1-5) minutes.
6. After one (1) minute the lettuce sections were removed from the dip tank using the colander and allowed to drain for approximately 30 seconds and then placed into a salad spinner for centrifugation.
7. The lettuce was centrifuged at approximately 800 rpm for 20-30 seconds.
8. After centrifugation the lettuce was placed into the colander and gently shaken to loosen the cut lettuce sections from centrifugal compaction.
9. The lettuce (300 gm) was then placed into a semi-permeable poly bag which was then heat sealed.
10. The bag was them placed into a refrigerator at 4° C.-6° C.
11. A “Control” sample was also prepared in the same way but dipping into water at the same temperature as the ABS 600 2% being 10° C.

Three (3) Samples were prepared as above but subject to different storage conditions.

Sample (1)—was made up of lettuce leaves and white stalk present.
Sample (2)—was made up of only white stalk sections from the iceberg lettuce.
Sample (3)—was a “Control” made up of lettuce leaves and white stalk present.

Trial Results: Sample (1)

| | Shelf Life in days | |
|---|---|---|
| Sample | (P+) | Comments |
| 1 | P+ (12.01.2012) | Fresh, Crispy/crunchy and a good colour. Taste was as lettuce no acidity detected. |
| 1 | P + 3 (15.01.2012) | Fresh, Crispy/crunchy and a good colour. |
| 1 | P + 7 (19.01.2012) | Fresh, Crispy/crunchy and a good colour. No sign of browning on the extremities of |
| | | the lettuce sections or pinking on the stalks. |
| 1 | P + 10 (22.01.2012) | Fresh, Crispy/crunchy and a good colour. No sign of browning on the extremities of |
| | | the lettuce sections or pinking on the stalks. |
| 1 | P + 13 (25.01.2012) | Fresh, Crispy/crunchy and a good colour. No sign of browning on the extremities of |
| | | the lettuce sections or pinking on the stalks. No evidence of stress or deterioration in |
| | | colour or texture. |
| 1 | P + 15 (28.01.2012) | Fresh, Crispy/crunchy and a good colour. No sign of browning on the extremities of |
| | | the lettuce sections or pinking on the stalks. No evidence of stress or deterioration in |
| | | colour or texture. |
| 1 | P + 17 (30.01.2012) | Fresh, Crispy/crunchy and a good colour. No sign of browning on the extremities |
| | | of the lettuce sections or pinking on the stalks. No evidence of stress or deterioration |
| | | in colour or texture. |
| | | At P + 17 the bag was opened for approximately 2 minutes to extract a sample for |
| | | tasting and allow inflow of air: Taste is very good and fresh to mouth feel. No |
| | | detection of softening of the lettuce leave structure. The bag was then resealed and |
| | | returned to the refrigerator. |
| 1 | P + 21 (03.02.2012) | As of 03.02.2012 (four (4) days after opening there are slight signs of pinking but no |
| | | browning and the general condition remains good. Taste and texture remain very |
| | | good. |
| 1 | Trial Comments | Considering the bags remained closed for 16 days before opening on the 17th day |
| | | (P + 17) there was no sign at all of the lettuce sections being under stress (indicated by |
| | | no evidence of condensation in the bag). The assumption is respiration continued |
| | | albeit at a reduced rate allowing a slow O₂ and CO₂ exchange to take place through |
| | | the semi permeable poly bags establishing an equilibrium concentration of both gases - |
| | | this is the rate of gas transmission through the bag is equal to the rate of respiration |
| | | (referred to as the “equilibrium modified atmosphere”). |

Test Results: Sample (2)

| Sample | Shelf Life in days (P+) | Comments |
|---|---|---|
| 2 | P+ (12.01.2012) | Fresh, Crispy/crunchy and a good colour. Taste was as lettuce no acidity |
| | | detected. |
| 2 | P + 3 (15.01.2012) | Fresh, Crispy/crunchy and a good colour. |
| 2 | P + 7 (19.01.2012) | Fresh, Crispy/crunchy and a good colour. No sign of browning or pinking |
| | | on the stalks. |
| 2 | P + 10 (22.01.2012) | Fresh, Crispy/crunchy and a good colour. No sign of browning or pinking |
| | | on the stalks. |
| 2 | p + 13 (25.01.2012) | Fresh, Crispy/crunchy and a good colour. No sign of browning or pinking |
| | | on the stalks. No evidence of stress or deterioration in colour or texture. |
| | | Bag was opened for approximately one (1) minute. |
| 2 | P + 15 (28.01.2012) | Fresh, Crispy/crunchy and a good colour. No sign of browning but slight |
| | | signs of pinking on the stalks. No evidence of stress or deterioration in |
| | | colour or texture. |
| 2 | P + 17 (30.01.2012) | Fresh, Crispy/crunchy and a good colour. No sign of browning but pinking |
| | | becoming more evident on the extremities of the stalks. No evidence of |
| | | stress or deterioration in colour or texture. Taste is very good and fresh to |
| | | mouth feel. No detection of softening of the stalk structure. |
| 2 | Trial Comments | This approach was to see the effect of ABS 600 2% on the hard white |
| | | stalk of iceberg lettuce in isolation from the greener leaves. At P + 13 the |
| | | bag was deliberately opened to allow air into the bag. After one (1) minute |
| | | the bag was resealed. At P + 17 although pinking is present the white |
| | | sections do not appear nor feel (to touch) offence. Removed with a sharp |
| | | knife you would not know pinking had been present. |

Test Results—Control Sample (3):

| Sample | Shelf Life in days (P+) | Comments |
|---|---|---|
| 3 | P+ (12.01.2012) | Fresh, Crispy/crunchy and a good colour. Taste was as lettuce no acidity |
| | | detected. |
| 3 | P + 3 (15.01.2012) | Fresh, Crispy/crunchy and a good colour. |
| 3 | P + 4 (16.01.2012) | Fresh, Crispy/crunchy BUT pinking appearing on the white stalks. |
| 3 | P + 5 (17.01.2012) | Condensation now on the inside of the bag. Pinking more evident and the |
| | | leaves are beginning to soften and sag. Bag Opened and a sample of the |
| | | lettuce was examined - soft with suspect taste change compared to fresh |
| | | lettuce. |
| 3 | Trial Comment | At P + 4 the lettuce was showing signs of distress with signs of condensation |
| | | on the inside of the bag. Pinking was also present. At P + 5 the appearance of |
| | | the lettuce was unsuitable and the taste questionable. |

Conclusion:

1. The trial has demonstrated that the ABS 600 has the ability to significantly extend the shelf life of ICEBERG LETTUCE as reported.
2. What is evident is the difference in shelf life achieved between
Sample (1) which contained green lettuce leaves and the thinner less bulkier white stalk sections and
Sample (2) which contained the larger bulkier structured white stalk sections.

The Sample (1) thinner white stalk sections have not at P+17 shown any sign of pinking or browning whilst Sample (2) larger bulkier white stalk sections begin to exhibit signs of pinking at P+15.

I am of the opinion that the larger and bulkier white stalk sections contain higher levels of PAL (Phenylalanine ammonia lyase) enzyme and ethylene activity.

General Observations and Comments:

The issue of varying degrees of browning in Iceberg lettuce is three fold:

### 1. PAL Activity.

2. Hormonal (Ethylene) activity.
3. RS Formation by yet another independent possible enzyme/hormone activity?

(It appears that Russet Spotting (RS) lesion development is independent of the increase in PAL activity and the accumulation of phenolic compounds that contribute to browning.)

Since a chain of physiological events is known to occur in the uncut surfaces before browning appears, variables such as conditions in the field, handling during transport, and variety of the lettuce could have influenced these events and caused variability in browning of the uncut surfaces in the different experiments.

The initial post-harvest trauma (wounding) caused by removing the lettuce from the tap root and exposure to the plant hormone ethylene (e.g. during storage and transport) stimulate the phenyl propanoid pathway and induce new enzymatic activity leading to increased production of the major phenolic compounds and the synthesis of new compounds well before the lettuce are processed within a Processing Plant environment.

As a preliminary test I did cut an Iceberg lettuce from its tap root and immediately dipped the end into FL 200 for 3 minutes. The lettuce white stalk did not show signs of browning/pinking for 6 days. If this post-harvest treatment could be achieved at the site of picking this could possibly minimise ethylene and enzyme activity prior to processing and packaging into poly bags.

### EXAMPLE 2a

Conditions:

The blender should be clean and satisfy Food Standard Conditions of Manufacture

Procedure A: Preparation of ABS 600 Powder Concentrate.

Add 7.00 kg sorbate to the mixing vessel.

Add 105.40 kg of citric acid and mix for 5 minutes.

Add 40 kg of sodium erythorbate and mix for 5 minutes

Add 302.58 ascorbic acid and mix for 5 minutes

Add 45 kg calcium salt and mix for 5 minutes.

Add 200 kg castor sugar and mix for 5 minutes.

Continue mixing for a further 10 minutes to ensure uniform intermediate distribution.

### EXAMPLE 2b

Procedure B: Milling

The ABS 600 powder produced from Example 1a) was transferred to a milling silo.

The powder was then milled to a particle size of 250 μm.

Once 250 μm had been achieved for 98% w/w of the powder is then passed for Certificate of Analysis (COA).

1. A method of preserving leafy vegetables which comprises treating the leafy vegetables with a processing aid composition, said processing aid composition comprising from about 0.01% w/w to 5% w/w salicylic acid or a salt or ester thereof.

2. A method according to claim 1 wherein the amount of salicylic acid; or a salt or ester thereof, present in the composition is from about 0.02% w/w to about 0.9% w/w.

3. (canceled)

4. A method according to claim 1 wherein the composition further comprises a source of calcium ions.

5. A method according to claim 4 wherein the source of calcium ions is calcium chloride (CaCl₂).

6. A method according to claim 4 wherein the amount of calcium salt present in composition is from about 65% w/w to about 95% w/w.

7. (canceled)

8. A method according to claim 1 wherein the composition includes one or more antioxidants.

9. (canceled)

10. A method according to claim 8 wherein the amount of antioxidant present in the composition is from about 5% w/w to about 25% w/w.

11. (canceled)

12. A method according to claim 1 wherein the composition includes one or more acidulants.

13.-16. (canceled)

17. A method of preserving leafy vegetables which comprises treating the leafy vegetables with a processing aid composition, said processing aid composition comprising salicylic acid; or a salt or ester thereof; a calcium salt, an antioxidant and an acidulant.

18. A method according to claim 1 wherein the composition comprises:
from about 0.01% w/w to 5% w/w salicylic acid, or a salt or ester thereof;
from about 65% w/w to about 95% (w/w) of a calcium salt;
from about 5% w/w to about 25% w/w of an antioxidant; and
from about 2% w/w to about 8% (w/v); of an acidulant;
not exceeding 100% w/w.

19.-20. (canceled)

21. A method according to claim 1 wherein the leafy vegetables comprise one or more of Batavia, COS and Romaine, Iceberg, Little gem lettuce, Lollo Rosso lettuce, oak Leaf lettuce, round lettuce, chard, endive, escarole, mizuna, radicchio, rocket, spinach, tatsoi and watercress.

22. (canceled)

23. A composition for use in preserving leafy vegetables in a process which comprises treating the leafy vegetables with a processing aid composition, said processing aid composition comprising from about 0.01% w/w to 5% w/w salicylic acid; or a salt or ester thereof.

24. A composition according to claim 23 wherein the amount of salicylic acid; or a salt or ester thereof, present in the composition is from about 0.02% w/w to about 0.9% w/w.

25. (canceled)

26. A composition according to claim 23 wherein the composition comprising from about 0.01% w/w to 5% w/w salicylic acid; or a salt or ester thereof; and source of calcium ions.

27. (canceled)

28. A composition according to claim 26 wherein the amount of calcium salt present in the composition is from about 65% w/w to about 95% w/w.

29. (canceled)

30. A composition according to claim 23 wherein the composition includes one or more antioxidants.

31. (canceled)

32. A composition according to claim 30 wherein the amount of antioxidant present in the composition is from about 5% w/w to about 25% w/w.

33. (canceled)

34. A composition according to claim 23 wherein the composition includes one or more acidulants.

35.-38. (canceled)

39. A composition according to claim 23, wherein said composition comprises salicylic acid; or a salt or ester thereof; a calcium salt, an antioxidant and an acidulant.

40. A composition according to claim 39 wherein the composition comprises:
from about 0.01% w/w to 5% w/w salicylic acid, or a salt or ester thereof;
from about 65% w/w to about 95% (w/w) of a calcium salt,
from about 5% w/w to about 25% of an antioxidant and
from about 2% w/w to about 8% (w/v); of an acidulant;
not exceeding 100% w/w.

41.-42. (canceled)

43. A method of preserving leafy vegetables according to claim 1 which comprises the steps of:
(i) shearing the leafy vegetables into desirably sized portions; and
(ii) treating the sheared leafy vegetables with the processing aid composition.

44. (canceled)
